(19) United States
(12) Patent Application Publication
(10) Pub. No.: US 2005/0234805 A1
(43) Pub. Date: Oct. 20, 2005

(54) Systems and methods for multiparty anonymous negotiation with incentives

(75) Inventors: Judith N. Robertson, Toronto (CA); Karl Abbott, Markham (CA); Douglas W. Gerhart, Toronto (CA); Donald R. Findlay, Toronto (CA); Roula Haddad, Toronto (CA); Eric E. Barnhorst, Toronto (CA); Douglas E. Steiner, Toronto (CA)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Markets Inc.

(21) Appl. No.: 11/076,901

(22) Filed: Mar. 11, 2005

Related U.S. Application Data
(60) Provisional application No. 60/563,016, filed on Apr. 19, 2004.

(51) Int. Cl. G06F 17/60

(52) U.S. Cl. 705/37

(57) ABSTRACT

Consistent with the present invention, systems, computer programs, and methods are provided for anonymously negotiating and matching buy and sell orders in a fungible asset trading market. Furthermore, systems and methods consistent with the present invention may provide a time-sensitive trading environment that encourages participants to continue negotiations for an asset until a mutually acceptable price is reached by providing a participant with an incentive to continue submitting orders, such as information concerning the other side's ordering actions, as long as the participant continues to negotiate in a timely manner.

### RELATED APPLICATIONS

This application is related to and claims priority of U.S. Provisional Application No. 60/563,016 entitled “SYSTEMS AND METHODS FOR AUTOMATED MEDIATION OF A MULTIPARTY ANONYMOUS NEGOTIATION” filed Apr. 19, 2004, which is incorporated herein by reference.

### DESCRIPTION OF THE INVENTION

1. Field of the Invention

This invention generally relates to automated systems for efficient asset markets, and more particularly, to systems and methods for anonymously negotiating market trades of fungible assets.

2. Background of the Invention

Fungible assets are a class of assets where each instance of a particular asset is interchangeable with another instance of the same asset. Examples of fungible assets include currencies, public securities, frequent flyer points, industrial commodities, and agricultural commodities. Real estate, on the other hand, is not a fungible asset.

Over time specialized markets have evolved for buyers and sellers to trade particular types of fungible assets in various ways. Examples of these specialized markets include stock exchanges, options exchanges, and commodities exchanges. Using these markets, a plurality of buyers and a plurality of sellers may negotiate and execute a plurality of trades. Each trade is a transaction wherein a particular buyer agrees to buy, and a particular seller agrees to sell, a particular quantity of a particular fungible asset at a particular price at the time of the trade.

Current conventional markets for trading fungible assets typically employ a public auction process to discover the price at which a particular quantity of a particular fungible asset may be bought or sold at a particular point in time. Current markets employ a variety of different auction methods, including the single-sided English auction, the two-sided English auction, and the Dutch auction.

The most common conventional auction process employed in conventional markets for fungible assets is the continuous two-sided English auction. In this auction process, the market continuously attempts to match the seller or sellers willing to sell a particular asset at the lowest price with the buyer or buyers willing to buy the asset at the highest price. Examples of markets that employ the continuous two-sided English auction process are The New York Stock Exchange, The London Stock Exchange, The Tokyo Stock Exchange, The Chicago Board of Trade, and the Toronto Stock Exchange.

To participate in a continuous two-sided English auction market, a buyer places an order to buy a particular quantity of a particular asset at a particular price, and a seller places an order to sell a particular quantity of a particular asset at a particular price. The orders placed by buyers are called bids, and the orders placed by sellers are called offers. For a particular asset trading in a particular market, the best bid is the bid at the highest price, and the best offer is the offer at the lowest price. The market attempts to match best bids and best offers to accomplish a trade. Participants negotiate in the market by adjusting their bids and offers. Whenever a buyer is willing to buy at the best offer price, or a seller is willing to sell at the best bid price, the offers match and a trade occurs between the parties.

In continuous markets, there is normally a gap or spread between the best bid price and the best offer price, with the bid price being lower than the offer price. As soon as the spread becomes zero, or when the best bid price exceeds the best offer price, the orders constituting the best bid and the best offer are matched and executed subject to any volume constraints, and a trade occurs. After the trade, the market returns to its normal condition with a spread between the best bid and offer prices.

To attract more orders, continuous markets typically advertise the currently prevailing best bid and offer in what is called a market quotation. Each market quotation describes for a particular fungible asset trading in a particular market the currently prevailing best bid price and best offer price, the quantity of the asset in demand at the best bid, and the quantity of the asset available at the best offer. High-speed telecommunications networks typically distribute market quotations so that they are available to market participants in real-time or near real-time.

The continuous-auction trading model, however, presents a number of problems for some buyers and sellers. For one, broadcasting market quotations informs the marketplace participants about the trading intentions of the most aggressive buyers and sellers in the market. In some cases, these aggressive buyers and sellers may wish to trade without publicly disclosing their trading intentions. For example, participants who seek to buy or sell large quantities (big blocks) of a particular fungible asset often do not want their intentions to become public, because the order information affects prices. The market tends to react to the perception of supply or demand created by the large order size, making prices higher or lower than they otherwise would have been. There are also many other types of participants who have reasons to wish to keep their orders secret.

Moreover, even if a participant tries to keep their orders from appearing as quotations by bidding or asking at the current market price, public quotation can still occur. Specifically, participants place orders to participate in an auction and, ultimately, a trade, and the market matches all orders continuously. Because there are inherent delays in placing a new order in a market, a particular order may not be executed when it is entered if another new order gets to the market first. Instead, it may end up constituting the best bid or offer and consequently be disseminated widely as a market quotation. In addition, many markets, such as the NASDAQ, use an open book order system, where all orders are available for public inspection regardless of whether they appear as market quotations.

Another problem is the limited amount of information supplied by conventional market quotations. A market quotation reveals only the prices and quantities of orders in the order book at that time. A market quotation does not represent the complete and accurate intentions of the participants interested in the particular fungible asset and market. For example, a participant who wishes to sell a large block, typically does so as several small orders. So, information on the small orders does not reveal the complete and accurate intentions of the participants. For a participant that wishes to trade quantities of a particular fungible asset that are substantially larger than the quoted quantities in the market, such as institutional investment managers, the continuous auction model typically does not supply information about the prices at which these larger quantities can be traded.

Several systems have been proposed to address some of the problems of conventional continuous auction trading model markets, but each has its drawbacks. U.S. Pat. No. 6,058,379, for example, discloses a system that allows participants to enter a series of orders, and other parameters, for a particular fungible asset, and the system optimizes execution satisfaction among all participants. This system, however, requires the entry of a large amount of data to affect a single trading intention, which is both complex and time-consuming. It also suffers from an undesirably small probability of execution of each order.

U.S. Patent Application Publication 2003/0093343 A1 discloses a system for facilitating the trading of large quantities of fungible assets by controlling the dissemination of order information. This system allows participants to control how much order information is disclosed, and to control to whom the information is disclosed. This system, however, does not easily allow for a constantly changing community of participants, and does not encourage or limit negotiation between participants.

U.S. Pat. No. 5,924,082 discloses a system that facilitates negotiation of trade details. The system identifies potential matches, introduces the buyer and the seller to each other, and provides a messaging structure to allow the buyer and seller to agree on the final terms of the trade. This system, however, is not suited for negotiations among multiple buyers and multiple sellers. It is also subject to abuse by participants who enter orders solely for the purpose of seeking information about orders on the other side and defeating anonymity. Also, this system does not encourage or limit negotiation between participants.

Accordingly, it is desirable to increase the efficiency of fungible asset trades and of asset price discovery by providing anonymity in the marketplace, and to provide incentives for participants to negotiate the price of an asset, resulting in a trade.

### SUMMARY OF THE INVENTION

In accordance with the principles of the present invention, systems, methods, and computer programs are provided for encouraging trades for fungible assets that include components for and operations comprising: receiving a first order associated with a fungible asset from a first participant; notifying a second participant that the order for the fungible asset has been received; receiving a second order for the fungible asset from the second participant; providing to the first participant an incentive to submit a new order associated with the fungible asset; determining, as a function of at least one criteria, whether to withdraw the incentive; and withdrawing the incentive based on whether the new order submitted by the first participant meets the at least one criteria.

In accordance with the principles of the present invention, apparatus and methods are provided for encouraging trading of a fungible asset comprising: receiving at least two complimentary orders for the fungible asset; notifying a plurality of participants with information regarding the at least two complimentary orders; starting a timer; determining a subset of the plurality of participants, wherein the subset contains only participants that have submitted a market-improving order for the fungible asset before the timer expires; and notifying the participants in the subset of the plurality of participants with information regarding the market-improving order.

Many objects and advantages of the invention will be set forth in part in the description which follows, and in part will be obvious from the description, or may be learned by practice of the invention.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and together with the description, serve to further explain the invention.

FIG. 1 is diagram representing two exemplary states associated with a market asset traded in a system consistent with present invention;

FIG. 2 is a flow chart illustrating an exemplary process consistent with the present invention that provides information to participants as long as they continue to negotiate;

FIG. 3 is a flowchart representing a top level process for incentivized negotiation in a market consistent with the present invention;

FIGS. 4A and 4B are diagrams representing the operating modes of an exemplary market exchange system consistent with the invention;

FIG. 5 is a timeline representing an exemplary sequence of trading events for an asset in a market system consistent with the invention; and

FIG. 6 illustrates an exemplary computing system that can be used to implement embodiments of the invention.

### DETAILED DESCRIPTION

Consistent with the present invention, systems, computer programs, and methods are provided for anonymously negotiating and matching buy and sell orders in a fungible asset trading market. Furthermore, systems, programs and methods consistent with the present invention may provide a time-sensitive trading environment that encourages and provides an incentive for participants to continue an anonymous negotiation until a mutually acceptable price is reached by providing incentives, such as information concerning the other side's ordering action as long as a participant continues to negotiate.

One embodiment of a market system consistent with the present invention provides a central order book and means for a plurality of participants to submit a plurality of orders to the central order book. In one embodiment the contents of the orders remain secret; in other embodiments some of the orders' information is available to market participants.

Each order submitted to the central order book is either a sell order or a buy order. A sell order is a commitment by a participant to sell up to a specified quantity of a specified fungible asset at a price equal to or higher than a specified limit price and a buy order is a commitment by a participant to buy up to a specified quantity of a specified fungible asset at a price that is equal to or less than a specified limit price.

A fungible asset is a particular class of assets for which each instance of the asset is essentially equivalent to another instance of the same class, and for which ownership interest in an instance of the asset class is readily transferable. Examples of fungible assets include public securities, publicly-traded futures contracts, publicly-traded options contracts, customer reward points, agricultural commodities, and industrial commodities. Real estate is not a fungible asset.

A limit price is a constraint on the price at which a buy order or sell order may be executed. In the case of an order to sell, the limit price is the minimum price that the seller will accept for each unit of the fungible asset sold. A higher price, however, is both acceptable and preferable. For an order to buy, the limit price is the maximum price that the buyer is willing pay for each unit of fungible asset purchased. A lower price, however, is both acceptable and preferable.

In one embodiment, as each new order is placed in to the order book, the system compares the new order with each order already residing in the order book and determines which, if any, existing order can be matched with the new order.

A particular new order matches a particular existing order when the following conditions are met:
1. a buy order can only be matched with a sell order, and vice-versa,
2. the buy order and sell order concern the same fungible asset, and
3. the limit price specified in the buy order is equal to or greater than the limit price specified in the sell order.

In one embodiment consistent with the invention, when more than one existing order can be matched with a particular new order, the system chooses the existing order with the highest priority to match with the new order. The system ranks the priority of existing orders based on their limit price and time of placement. More specifically, the potentially matching existing orders are first ranked by price. In the case of buy orders, an order with a higher limit price ranks ahead of an order with a lower limit price. In the case of sell orders, an order with lower limit price ranks ahead of an order with a higher limit price. Among orders at the same price, an order with an earlier time of entry into the system ranks ahead of an order with a later time of entry. In another embodiment, existing orders are ranked by other criteria, such as whether their quantity satisfies the new order's quantity. In yet another embodiment, orders are not ranked, but instead matches are made on a pro rata basis, or based on a variation of pro rata matching.

When a particular new order matches a particular existing order, a trade is executed. The participant who submitted the sell order sells, and the participant who submitted the buy order buys, a quantity of the particular fungible assets specified in the matching orders that is equal to the lesser of the quantity specified in the buy order and the quantity specified in the sell order. In one embodiment, the transaction occurs at a price that is equal to the average of the limit price specified in the buy order and the limit price specified in the sell order. (Note condition 3 above). The particular fungible asset exchanged when two orders match is referred to the traded asset, the quantity of the fungible asset exchanged is referred to as the trade size, and the price paid by the buyer for each unit of the traded asset is referred to as the trade price.

In one embodiment consistent with the invention, any new order submitted to the central order book that cannot be matched with an existing order at the time it is submitted is added to the order book and remains there until either it is cancelled or matched with a subsequent order. In other embodiments, orders may be deleted if they cannot be filled immediately. In yet other embodiments, orders may expire after being in the order book and unmatched for a specified time period.

In one embodiment consistent with the invention, the order book is a database or other data repository that contains previously created orders that have not been matched and executed or cancelled.

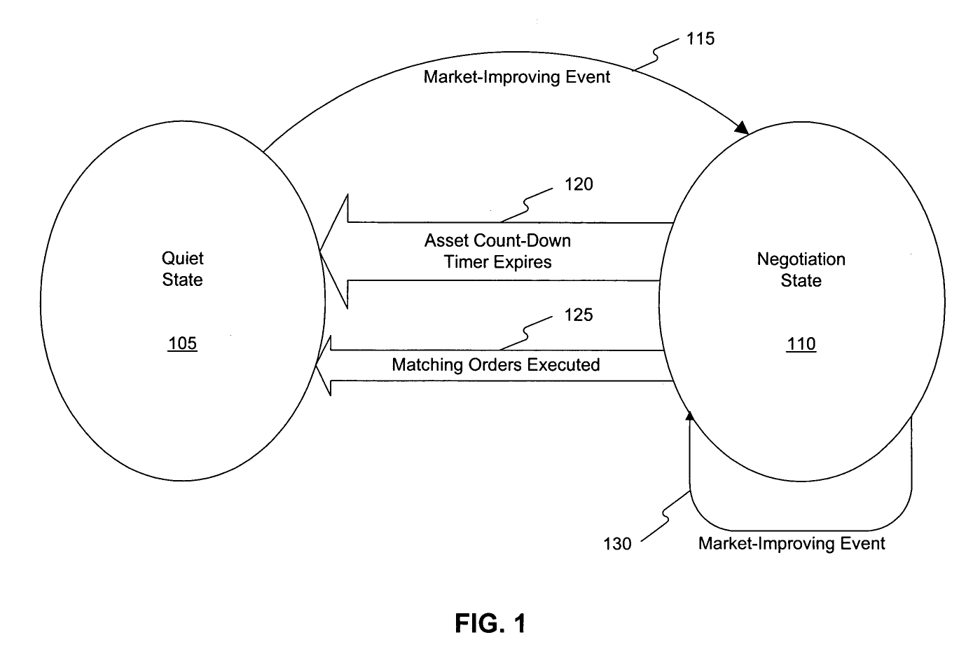

FIG. 1 is diagram representing two exemplary states associated with a market asset traded in a system consistent with present invention. In the embodiment shown, an asset may be in either the quiet state 105 or the negotiation state 110. In one embodiment, at the beginning of a trading session, substantially all assets are set to the quiet state 105. A transition from the quiet state to the negotiating state 115 occurs for an asset when a market-improving event 115 for that asset occurs.

In one embodiment, the following comprise market-improving events for a particular asset:
1. Receipt by the system of a new buy order for the asset from any participant, if there are no existing buy orders,
2. Receipt by the system of a new sell order for the asset from any participant, if there are no existing sell orders,
3. Receipt by the system of a new buy order for the asset from any participant, wherein the participant has no order currently outstanding for the asset,
4. Receipt by the system of a new sell order for the asset from any participant, wherein the participant has no order currently outstanding for the asset,
5. Receipt by the system of new buy order for the asset from any participant, wherein the participant has one or more buy orders outstanding for the asset, and wherein the new buy order has a price higher than any other buy order already outstanding for that participant, and
6. Receipt by the system of a new sell order for the asset from any participant, wherein the participant has one or more sell orders outstanding for the asset, and wherein the new sell order has a price lower than any other sell order already outstanding for that participant.

In other embodiments consistent with the invention, more, fewer, or other definitions of different market-improving events 115 can be used, such as a change in a reference market price in an embodiment where orders in the market system (e.g., pegged orders) are priced based on a reference market. For example, where the price of an order in a continuous auction market is specified as being equal to the best bid price in the reference market, wherein the New York Stock Exchange is used as the reference market.

In one embodiment consistent with the invention, when a market-improving event 115 moves an asset from the quiet state 105 to the negotiating state 110, market participants are notified that the relevant fungible asset has entered the negotiation state 110. In this embodiment, a countdown timer is assigned to the asset that has entered the negotiating state 110. When a countdown timer is assigned to a particular asset, it is set to a specified time-out value, and the timer begins to count down to zero at a constant rate, defining the length of a negotiation session. In some embodiments, the time-out value may be different for different assets. For example, a highly liquid security that trades often may have a shorter time-out value, while a seldom-traded security may have a longer time-out value. If a particular participant initiates a market-improving event 130 for a particular asset that is already in the negotiating state, the participant becomes eligible to take part in the next negotiation session and to receive incentives. If a particular participant does not initiate a market-improving event 130 for the asset before the timer expires, then the participant will not receive incentives and/or further information about negotiation events for that asset, such as new market-improving events 130 initiated by other participants, in the current or future negotiation sessions.

In other words, when a market-improving event 130 occurs for a particular asset in the negotiating state, all the participants who are eligible are notified that the market in that particular asset has improved. Thus, participants who continue to negotiate by entering new orders on a timely basis remain eligible and continue to receive information about other participants' orders for the asset, and participants who do not timely submit an order cease to receive information about other's orders. Maintaining a continued flow of information is one example of an incentive to a participant to continue negotiating by submitting orders.

One of ordinary skill will recognize that other incentives instead of, or in addition to, order information may be provided to participants who continue to negotiate in a timely manner within the principles of the invention. For example, other incentives may include asset price information from a reference market, discounts on commissions or fees, discounts on the executed trade price from the bid/ask price, information regarding whether the latest order(s) on the other side of the order book is reasonable, and preferred order-matching rankings, among others.

As explained, when a particular asset enters the negotiation state 110 a countdown timer is assigned to that asset. The asset countdown timer is set to a specified value called the asset timeout value and begins to count down to zero. If no market-improving event 130 for that asset occurs before its countdown timer reaches zero, the asset leaves 120 the negotiating state 110 and returns to the quiet state 105. If a market-improving event 130 occurs for a particular asset that is in the negotiating state 110, the countdown timer for that asset is reset to the asset timeout value and resumes counting down toward zero at a constant rate. If a market-improving event occurs that also causes two or more orders in the order book to match, the orders are executed 125, and the relevant asset moves from the negotiating state 110 to the quiet state 105.

When a particular asset leaves the negotiating state 110 and returns to the quiet state 105, the countdown timer for the asset is removed.

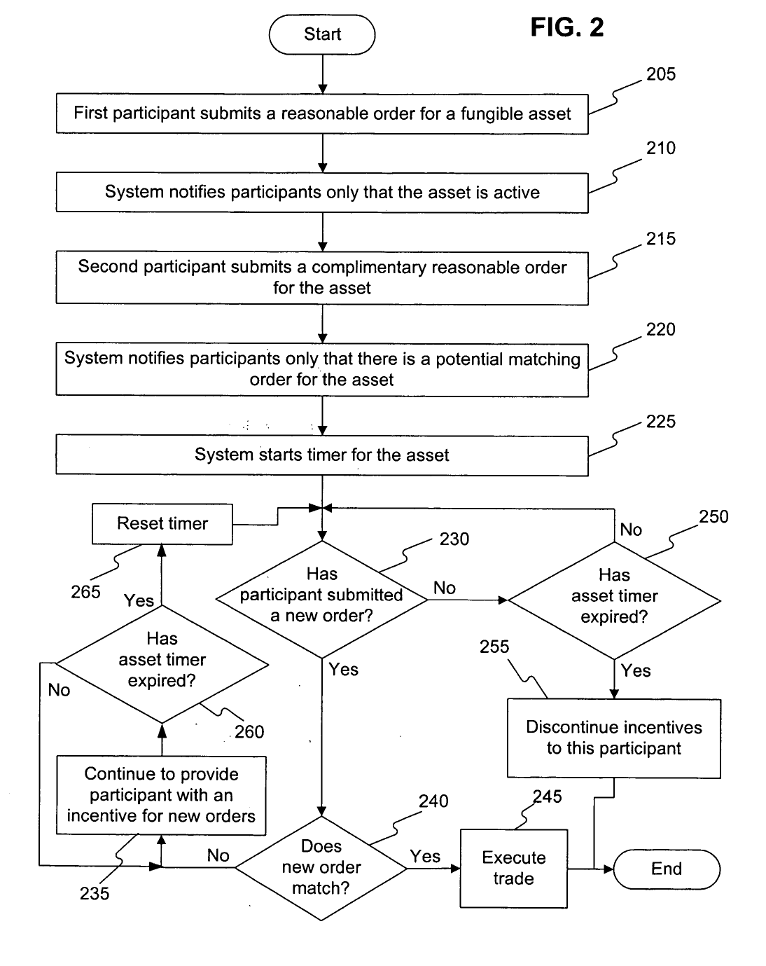

FIG. 2 is a flow chart illustrating an exemplary process that provides information to participants as long as they continue to negotiate by submitting orders within time limits, which encourages continued negotiation between the participants. Such a process may be implemented, for example, as a software application or applications running on a general-purpose data processing system, as a dedicated, hardwired, data processing system, or as a combination of the two. The exemplary process begins as a first participant submits a reasonable order for a specified fungible asset, such as a security (step 205). In reaction, the market system notifies all or substantially all the market participants that the specified fungible asset is active (step 210). In one embodiment, the notification to the market participants does not include the specifics of the order, such as bid/ask price and quantity. In other embodiments, the notification may include specific information about the order. Notification may be via email, instant messaging, a custom pop-up window, a custom software application, voice synthesis, phone call, fax, icon change, or other form of communication that can convey the asset's identity and status.

Typically in reaction to the notification, a second participant submits a complimentary reasonable order for the asset (step 215). A complimentary reasonable order may be a buy order for the asset in response to the first participant's sell order, or vice versa.

In one embodiment consistent with the invention, an order is reasonable if the order's buy price is above an acceptable minimum buy price or its sell price is below a maximum acceptable sell price. In one embodiment, the acceptable minimum buy price is a specified percentage, such as 1%, 5%, 10%, or more, below the lower of the previous day's closing price and the current day's low price, and the acceptable maximum sell price is a specified percentage, such as 1%, 5%, 10%, or more, above the higher of the previous day's close price and the current day's high price. In another embodiment the reasonable order price is a price within the absolute difference between the previous close price and the last traded price in a reference market, such as the primary market for the asset. In yet another embodiment, the reasonable order price is a price improvement by a meaningful increment, where the increment is predefined and is based on the best pending order for the asset, such as plus (or minus) 50 cents from the best pending buy (or sell) order for a security that trades in the 20 dollar range. In other embodiments consistent with the invention, other variables may be used to determine reasonableness, acceptable minimum buy price, and acceptable maximum sell price, including variables such as the previous day's closing price, the last sale price, the current day's high price, the current day's low price, and the high and low prices for a range of recent days, among others. In yet another embodiment consistent with the invention a pegged order, which is an order that floats in price both up and down according to a current market quotation, is not considered to be a reasonable order.

In reaction to the complimentary order, the system notifies all or substantially all the market participants that there is a potential matching order for the asset (step 220). Next, the system starts an asset timer that demarcates a period during which participants must act to continue negotiations and thus continue to receive incentives, such as information regarding orders for the asset (step 225).

As shown in the example, the process loops while the asset timer is running, first determining whether a participant has-submitted a new order for the asset (step 230). If the participant has submitted a new order (step 230, Yes), the process determines whether the participant's new order results in a match (step 240). If the new order matches an existing order (step 240, Yes), then a trade is executed for the matching orders (step 245), and the process ends. If, on the other hand, the new order does not result in a match (step 240, No), then the process continues to provide incentives to the participant to submit further orders, such as notifying the participant regarding new information about the asset, such as the entry of new orders from other participants (step 235).

In step 260, the system checks whether the asset timer has expired. If not, (step 260, No) the participant continues to receive incentives, as represented by the loop back to step 235. If the timer has expired (step 260, Yes), the system resets the timer to start a new negotiation session (step 265), and loops back to step 230.

If the participant has not submitted a new order (step 230, No), then the process determines whether the asset timer has expired (step 250). If the asset time has not expired (step 250, No), then the process continues to loop and check for new orders from the participant. If the asset timer has expired (step 250, Yes), then the process ceases to provide incentives to the participant, such as information regarding the asset (step 255), and the process ends with respect to that participant. Thus, as long as a participant continues to negotiate the trade price of an asset by submitting new price-improving orders before the asset timer expires for a negotiation session, the participant continues to receive incentives, such as up-to-date-information about other orders for the asset submitted by other participants. If a participant waits too long before submitting an order, then the incentives, such as information flow regarding the asset, cease. Maintaining access to the information flow is an encouragement for a participant to continue negotiating and submitting orders for the asset in a timely manner. As noted above, the scope of the invention includes providing other incentives to participants that continue timely negotiations.

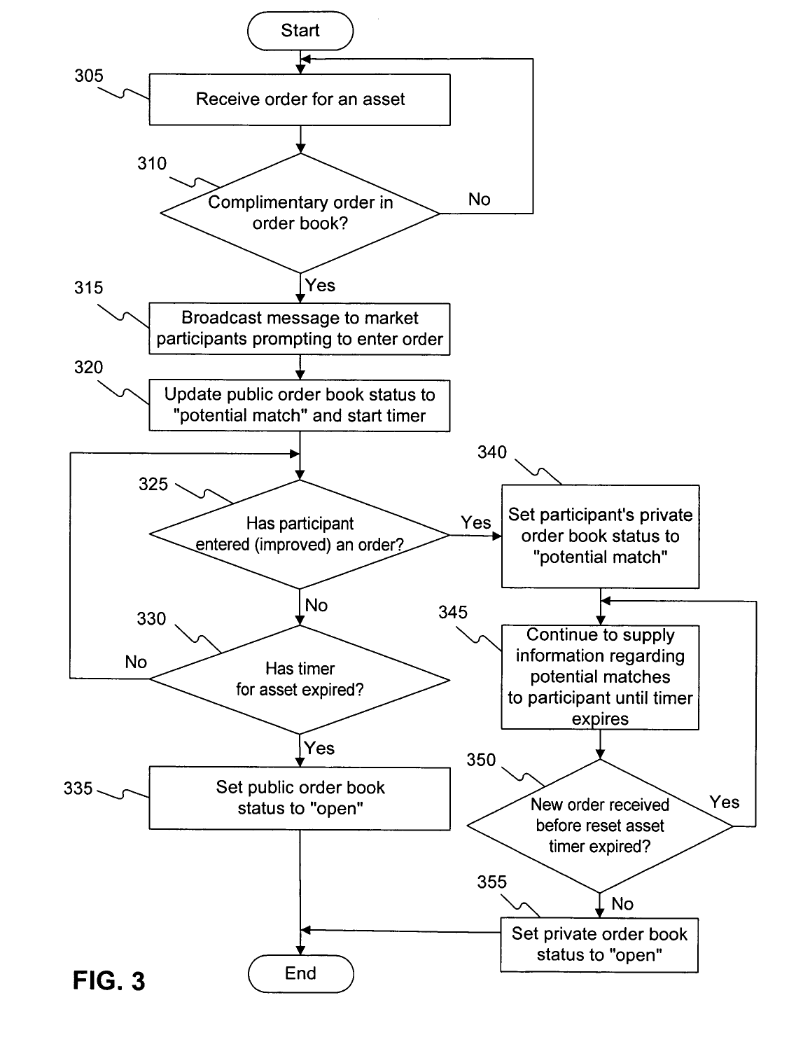

FIG. 3 is a flowchart representing a top level process for incentivized negotiation in a market consistent with the present invention. Such a process may be implemented, for example, as a software application or applications running on a general-purpose data processing system, as a dedicated hardwired data processing system, or as some combination of the two. As shown, the process begins when the system receives an order for an asset (step 305), such as when a market participant enters a new order or improves the price of an existing order, that does not result in an immediate match with an existing order for the asset. Next, the process determines whether at least one complimentary order exists on the other side of the order book from the received order (step 310). For example, if a buy order is received for an asset, the system determines whether a sell order for the same asset exists in the order book.

If there is no complimentary order in the order book (step 310, No), then the process waits to receive another order (loop back up to step 305). If, on the other hand, there is a complimentary order in the order book (step 310, Yes), then the system broadcasts a message to participants notifying them of the event and requesting participants to enter new orders or to improve existing orders for the asset (step 315). In one embodiment, the orders are evaluated for reasonableness, and if an order is unreasonable, then it is ignored by the process.

Next, the system updates the public order book status to “potential match” and starts a timer for the asset (step 320). In one embodiment, market participants see public order book status in a public watch list, for example displayed in a window on the screen of a participant's computer. In one embodiment, no further broadcast messages regarding the asset are sent to all participants while any negotiation (e.g., the entry of new orders among participants) for the asset is active.

Next, the system determines whether a participant has entered a new order for the asset or updated/improved an existing order (step 325). If not (step 325, No), the system checks whether a timer for the asset has expired to determine whether participants still have time to enter an order (step 330). In one embodiment, the timer is started when the public order book status is updated to potential match (step 320) and counts down from some initial value, such as 60 seconds or 90 seconds.

If the timer has not expired (step 330, No), then the process loops back to check whether a new order has been entered (step 325). If the timer has expired before a new order has been entered (step 330, Yes), then the system sets the public order book status for the asset to “open” (step 335), and ends.

If a new order has been entered by a participant (step 325, Yes), then the system sets the participant's private order book status to “potential match” (step 340). In one embodiment, eligible market participants see their private order book status in a private watch list, for example displayed in a window on the screen of the participant's computer.

Next, the system continues to supply information regarding potential matches for the asset and/or other incentives until the timer expires (step 345). Typically, such information comes from orders for the asset from other participants. In the embodiment shown, the participant is eligible to receive this information and/or other incentives because he or she entered a market-improving order for the asset (see step 325, Yes). Thus as shown, any participant who enters a new order or improves an existing continues to generate and receive messages regarding a potential match for the asset.

Next, the system determines whether it received anew orderfrom the participant before the expiration of the asset timer, which was reset for a new negotiation session (step 350). In one embodiment, the timer is restarted each time a market improving order is received from the participant, counting down from some initial value, such as 60 seconds or 90 seconds. In another embodiment, the timer is reset only if a market-improving complimentary order from another participant is also received. In another embodiment, the timer is reset to the initial value, such as 60 or 90 seconds, if there have been marking-improving events before the timer expired and after the previous time the timer was reset.

If a new order is received before the timer expires (step 350, Yes), which signifies that the participant continues to timely negotiate the price of the asset, then the system supplies information to the participant regarding any potential match created by the new order and orders by other negotiating participants, and/or other incentives (step 345). If the new order results in a match (not shown), then the system executes the trade and discontinues the loop of steps 345 and 350.

If no new order is received before the timer expires (step 350, No), which signifies that the participant has ceased timely negotiation, then the system sets the participant's private order book status to “open” for the asset (step 355), and the process ends. Similarly, in one embodiment consistent with the invention, if no market-improving orders from any participants occur within a set time period, then all private order book statuses for the asset for all eligible participants are reset to “open.”

One of ordinary skill will recognize that the process steps shown in FIGS. 2 and 3 are limited for clarity to show a basic example from the point of view of one participant, and that the process may easily be expanded to cover two, three, or more participants that submit orders for a particular asset. One of ordinary skill will further recognize that the process steps shown in FIGS. 2 and 3 may be easily modified, added to, or deleted without departing from the principles of the invention. For example, a step may be added to notify negotiating participants of the specific price and quantity of new orders received for an asset instead of or in addition to the general potential-matching-order notification. For another example, steps could be added such that each individual participant has their own timer that measures the period during which each participant must submit an order to continue negotiations, independent of the timers for the asset and the other participants.

In one embodiment, the system includes an order book status component that displays information to participants about current activity in the order book for each security relative to each participant. The information displayed as order book status depends on both the state of the order book for an asset and the state of a participant's orders, if any, within the order book. Thus, the order book status for an asset, such as a publicly traded security, may be different from one participant to another. In one embodiment, the statuses of several assets may be displayed in a watch list format, as is well-known in the art of security trading market displays.

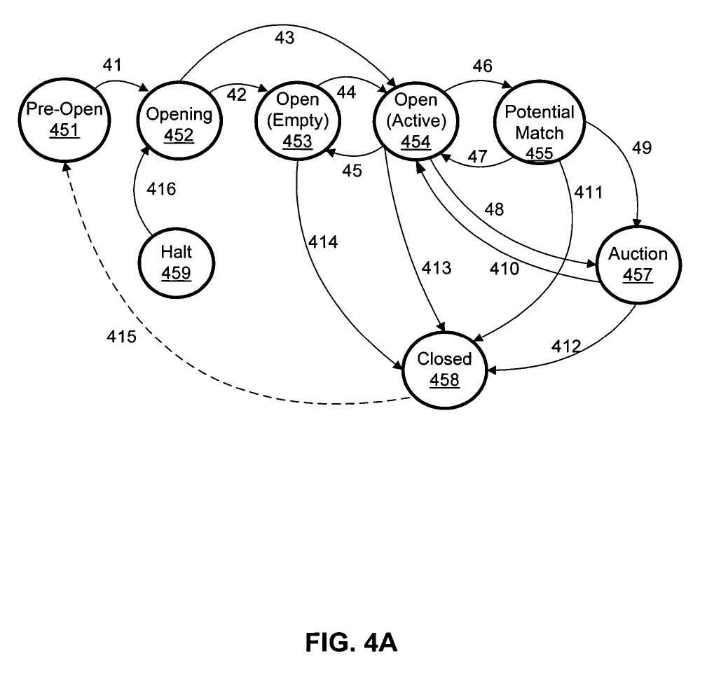

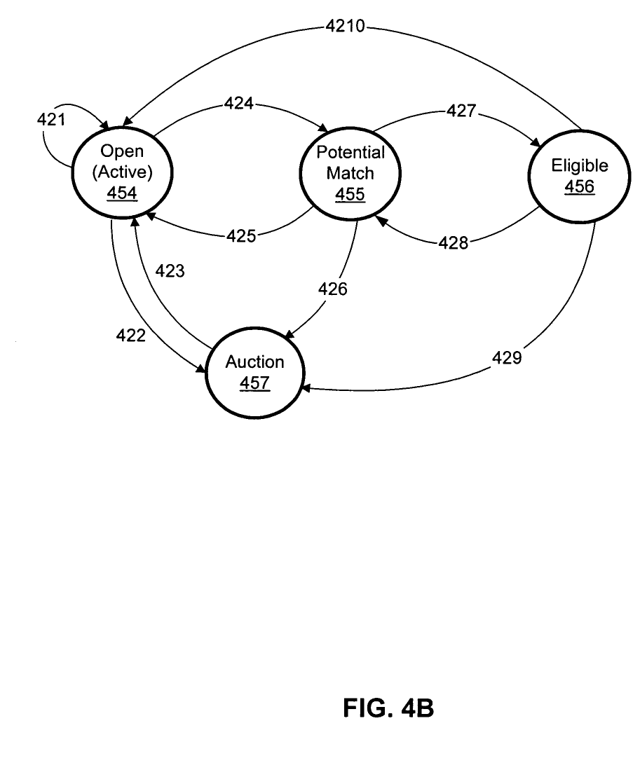

FIGS. 4A and 4B are diagrams representing the operating modes of an exemplary market exchange system consistent with the invention. FIG. 4A represents the perspective of an exemplary automated trading system that operates in accordance with the invention, in which an asset moves from the quiet state to the negotiation state. The system returns to the quiet state for an asset when the negotiation comes to an end. Participants may join or leave the negotiation according to their behavior in submitting orders.

In the system perspective embodiment shown in FIG. 4A, the system starts in the pre-open mode 451 before a trading session begins. The pre-open mode 451 may commence at a predetermined time before the trading session begins, for example three and one half hours before the trading session opens. In one embodiment, in the pre-open mode 451 the system accepts orders for assets traded by the market exchange system, but the orders are simply entered into the order book and held. The orders are not matched or executed during the pre-open mode 451.

The system transitions 41 from the pre-open mode 451 to the opening mode 452 when the market opening time arrives, for example 9:30 a.m. on weekdays. In the opening mode 452, the market system checks the order book for each asset traded in the market to identify and execute any matching orders and determine which mode to next enter.

If the order book for a given asset contains no orders after any pending, matching orders are executed, then the system transitions 42 from the opening mode 452 to the open (empty) mode 453 for the asset. If, on the other hand, the order book for a given asset contains at least one order (either buy or sell) after any pending matching orders are cleared, then the system transitions 43 from the opening mode 452 to the open (active) mode 454 for the asset.

The system waits in the open (empty) mode 453 for a given asset until either the trading session ends for the day, which causes a transition 414 to the closed mode 458 for the asset, or an order for the asset is received, which causes a transition 44 to the open (active) mode 454.

In one embodiment, when an asset enters the open (active) mode 454, the system notifies all or substantially all market participants of this fact, thus alerting them that there is new order activity for the asset. This notification informs participants that the conditions are favorable for negotiating a trade of the asset.

From the open (active) mode 454 for an asset, the system may transition to any of several different modes depending on the stimulus received while in the open (active) mode 454. Specifically, if the stimulus is the cancellation of the last order for a given asset in the order book, then the system transitions 45 from the open (active) mode 454 to the open (empty) mode 453 for that particular asset. If the stimulus is the reception of a reasonable order for a given asset on the other side of the order book from the side of the order that triggered the transition (43 or 44) into the open (active) mode 454 (i.e., a new buy order where a sell order triggered the transition into the open (active) mode 454, or vice-versa), then the system transitions 46 from the open (active) mode 454 to the potential match mode 455 for that particular asset. If the stimulus is the reception of a new order or an improved order for a given asset that matches an existing order in the order book, then the system transitions 48 from the open (active) mode 454 to the auction mode 457 for that particular asset. And, if the stimulus is the expiration of the trading session, then the system transitions 413 from the open (active) mode 454 to the closed mode 458.

The system enters the potential match mode 455 when at least one order exists on both sides of the order book for an asset (i.e., a buy order and a sell order). In this mode, the system makes available incentives, such as new information regarding negotiations for the asset, to participants who qualify for the incentives. The system does not make incentives available to non-eligible participants. Such incentives may include discounts, a “new order” announcement, details of the latest bid or offer for the asset, or other information useful in negotiations for the asset.

For example, in one embodiment, when a reasonable order for an asset triggers a transition 46 to the potential match mode 455, the system notifies market participants that the asset has a potential match, including notifying both participants who do and do not have an order pending for the asset. This notification occurs after the market participants have been publicly notified that the asset entered the open (active) mode 454, thus alerting them that there is now a potential matching order for the order that caused the initial open active notification and encouraging them to enter orders of their own if they are interested in the asset. In one embodiment, the notification generated during the potential match mode 455 prompts participants to enter orders and thus participate in any private negotiation sessions that follow. If another new or improved order is subsequently entered for the asset, the system notifies eligible participants with information regarding the new order, but the system does not notify non-eligible participants regarding subsequent orders. This is explained below in further detail with regard to FIG. 4B.

From the system perspective, from the potential match mode 455, the system may transition to either the auction mode 457, back to the open (active) mode 454, or to closed mode 458, depending on the stimulus, or lack of stimulus, received from market participants or other sources. Specifically, if a participant submits a new order (or modifies an existing order) for a given asset that matches an existing order in the order book, then the system transitions 49 from the potential match mode 455 to the auction mode 457 for that particular asset, generating a trade for the asset. If participants do not provide an improved-order stimulus in the potential match mode 455, for example, do not submit a reasonable order for the asset in the potential match mode 455 before a specified period of time has elapsed (such as 15 seconds, 30 seconds, or 60 seconds) since entering the potential match mode 455, then the system transitions 47 to open (active) mode 454 for that asset. And, if the trading session ends, then the system transitions 411 to closed mode 458.

In the auction mode 457, matching orders are executed and a trade occurs. This mode is conventional and the exact implementation chosen is not critical to the invention. From the auction mode 457, the system may transition 412 to closed mode 458, or transition 410 to open (active) mode 454. The stimulus for the system to transition 412 to the closed mode 458 is the expiration of the trading session, for example, at 4:00 p.m. weekdays. The stimulus for transitioning 410 to open (active) mode 454 is the end of the auction (e.g., completion of a trade) with unfilled orders still pending. In open (active) mode 454, trading and anonymous negotiation for the asset may continue during a trading session.

In the closed mode 458, no activity takes place among the system and the participants. The system transitions 415 from the closed mode 458 to the pre-open mode 451 at a predetermined time before the start of a trading session, such as 6:00 a.m. on weekdays.

The system will transition (not shown) to halt state 459 from any other state if a halt is received. From halt state 459, the system transitions 416 to opening state 452 when the halt is removed. Halts are known in the art, and the specific reasons for and implementation of halts is not critical to the invention.

FIG. 4B represents a subset of system states from the perspective of participants in the market. Generally, a participant may join a negotiation for an asset by improving or creating orders and leave a negotiation by failing to submit a reasonable order before the expiration of each timed negotiation session. In one embodiment, participants who are currently participating in a negotiation receive an indication, such as an icon or symbol that may be displayed on their computer screen, of a potential match. Participants not participating in the negotiation receive a symbol status indicating “open with orders.”

As shown in FIG. 4B, from a single participant's perspective, after an asset enters the open (active) mode 454, and the system notifies all or substantially all market participants of this fact, the system may transition to any of several different modes depending on the stimulus received while in the open (active) mode 454. Specifically, if the stimulus is the reception from the participant of a new or improved order that does not cause a negotiation (e.g., because there is no complimentary reasonable order on the other side of the order book), then the system remains 421 in the open (active) mode 454, and from the participant's perspective nothing changes. If the stimulus is the reception of a new or improved order from the participant (or some other participant) that matches an existing order(s) in the order book, then the system transitions 422 from the open (active) mode 454 to the auction mode 457 for that particular asset. And, if the stimulus is the reception of a new or improved order from the participant (or some other participant) that has a complimentary (though not matching) order on the other side of the order book, then the system transitions 424 from the open (active) mode 454 to the potential match mode 455 for that particular asset. In one embodiment, the system determines whether the new or improved order meets reasonableness criteria before transitioning 424 to potential match mode 455. If the order is not reasonable, for example an increase of one cent on the buy price of a stock currently quoted at 50 dollars per share, then no transition 424 occurs.

In one embodiment, when in potential match mode 455, the participant sees an indication that he or she is in a negotiation for an asset with another participant. For example, a potential match icon may display on the participant's screen along with a timer that counts down the time remaining until the end of the ongoing negotiation session. During a negotiation, two or more participants enter compatible orders in a timely fashion, and each successive order brings the participants closer to a match. Thus, when at least two orders are first entered on opposite sides of the order book for an asset (i.e., a buy order and a sell order), a negotiation starts and the system initiates the potential match mode 455.

In one embodiment, the system tolls a predefined time period during potential match mode 455 and transitions according to the stimulus (i) received during that period. From the participant's perspective, the system may transition to any of three different modes depending on the stimulus, or lack of stimulus, received while in the potential match mode 455. From the potential match mode 455, the system may transition to either the auction mode 457, back to the open (active) mode 454, or to eligible mode 456.

More specifically, if the participant enters or improves an order for the asset while the system is in potential match mode 455, then the system responds to this stimulus by transitioning 427 from the potential match mode 455 to the eligible mode 456 for that asset and participant. In one embodiment, the order must be reasonable to trigger transition 427.

If the participant, (or another participant) submits a new order (or modifies an existing order) for a given asset that matches an existing order in the order book, then the system transitions 426 from the potential match mode 455 to the auction mode 457 for that particular asset, generating a trade for the asset.

If the participant does not provide an appropriate stimulus during potential match mode 455, that is, does not submit an order for the asset in the potential match mode 455 before a specified period of time has elapsed (such as 15 seconds, 30 seconds, or 60 seconds) since the beginning of the current negotiation session, then the system transitions 425 back to open (active) mode 454 for that participant, independent of the modes of other participants that have submitted an order for the asset. In one embodiment, to indicate to the participant that they have dropped out of the negotiation, the system may display to the participant a countdown timer that reaches zero, indicating the end of the current negotiation session, and then change the display of a mode icon from a potential match mode indication to an open (active) mode indication.

Participants that transitioned to eligible mode 456 gain the advantage of additional information, such as information regarding subsequent orders for the asset by other participants, and/or other incentives, as a negotiation continues. The additional information may be “new order” announcements, details of the latest bid or offer for the asset, or other information useful in negotiations for the asset. The system does not make the same incentives available to participants that are not in potential match mode 455 or eligible mode 456.

Being in eligible mode 456 allows the participant to participate in the next negotiation session, if it occurs. From the participant's perspective, the system may transition from the eligible mode 456 to either the auction mode 457, the potential match mode 455, or the open (active) mode 454, depending on the stimulus received or lack of stimulus. More specifically, if another participant enters or improves an order that immediately produces a match, then the system transitions 429 from the eligible mode 456 to the auction mode 457, and a trade occurs.

If no other participant enters an improved order on the other side of the order book during a negotiation session, then the system transitions 4210 to the open (active) mode 454, ending the ongoing negotiation for the asset. In one embodiment, transition 4210 occurs when a time period for a negotiation session expires, such as 60 seconds from the entry of the order that caused the initial transition 424 to potential match mode 455, or 60 seconds from the expiration of the preceding negotiation session. As described in one example above, the time remaining in the time period and current mode may be presented to the participants in the form of countdown timers, icons, and other screen displays.

From the participant's perspective, if another participant enters or modifies an order that improves the price on the other side of the order book without causing a match, then the system transitions 428 from the eligible mode 456 back to the potential match mode 456, extending the negotiation for the asset. Participants in potential match mode 455 and eligible mode 456 receive incentives to continue negotiating as long as they stay in those modes, but the incentives are not made available to participants who transition to open (active) mode 454 or other modes. In one embodiment, transition 428 occurs for all participants in the eligible mode 456 at the expiration of a negotiation session, and a new negotiation session with a new time period begins following transition 428. In another embodiment, transition 428 occurs for the participant at some other time, such as when the first order that improves the price on the other side of the order book without causing a match is received, or according to a timer associated with the participant.

In the auction mode 457, matching orders are executed and a trade occurs. This mode is conventional and the exact implementation chosen is not critical to the invention. From the participant's perspective, from auction mode 457 the system may transition 423 to open (active) mode 454 so that trading and anonymous negotiation for the asset may continue during a trading session.

In one embodiment consistent with the invention, continuous auction trading continues in parallel with any negotiation sessions for an asset, and the occurrence of a trade of an asset (for example, triggered by a new matching order received in the open (active) mode 454 that causes a transition 422 to auction mode 457) for which a negotiation is in progress, causes the negotiation session to end. In another embodiment, a negotiation session may continue regardless of a continuous auction trade.

One of ordinary skill in the art will recognize that the system modes represented in FIGS. 4A and 4B are not mutually exclusive and that the system may be in the same or different modes simultaneously for different assets in the market and may be in two or more modes simultaneous for each asset in the market, depending on how participants react and on the details of system design. For example, the system may be in potential match mode 456 for one subset of participants who are negotiating for an asset and in open (active) mode 454 for the remainder of the market participants with respect to that asset. Further, one of ordinary skill will recognize that the illustrated modes and transitions may be modified, added to, or subtracted from without departing from the principles from the principles of the invention. For example, the pre-open mode 451 may be eliminated within the scope of the invention.

For clarity of explanation, the processes and modes shown in FIGS. 1-4 generally represent the operations and modes applied to a single market participant for a single asset. One of ordinary skill will recognize that in actual usage, the processes and modes apply to all market participants and all assets in the market, which application may be accomplished, for example, by looping all or a subset of the process operations and changing the target market participant and/or asset for each iteration of the loop, and by allowing assets and participants to enter modes independently and in parallel. One of ordinary skill will further recognize that the process steps and modes shown in the figures may be modified, added to, or deleted without departing from the principles of the invention. One of ordinary skill will also recognize that within the scope of the invention a system may provide appropriate feedback to participants, in the form of on-screen timers, icons, text, color changes, or otherwise, regarding the start, end, and length of the negotiation sessions, the participant's current mode for each asset, whether the participant has performed actions making him or her eligible for the next negotiation session, the price change needed to constitute a reasonable order, whether the participant's last order was reasonable, etc.

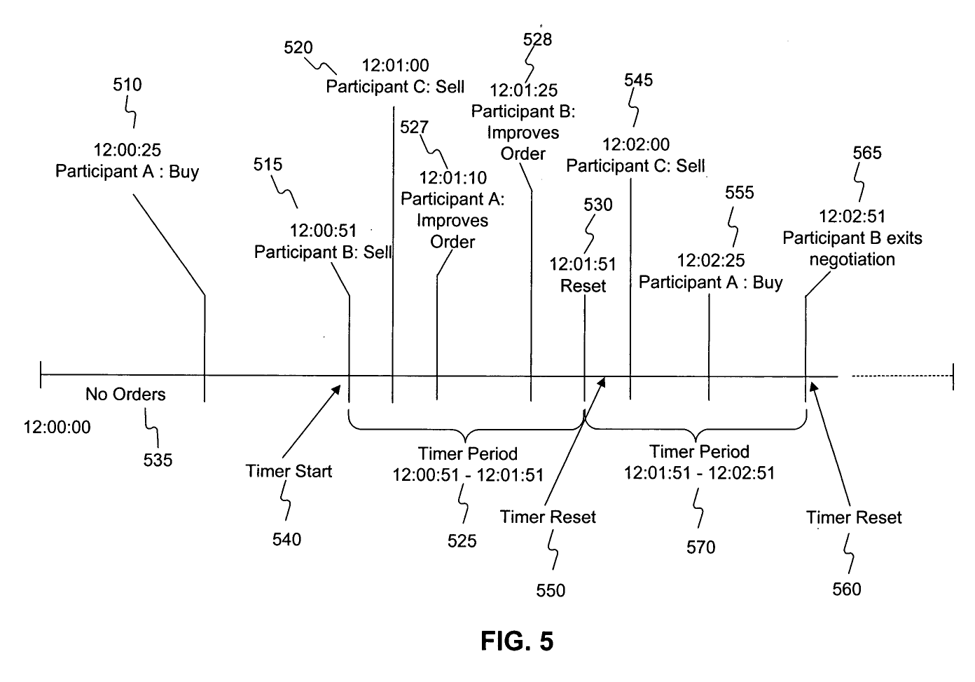

FIG. 5 is a timeline representing an exemplary sequence of trading events for an asset in a market system consistent with the invention. In the example shown, it is assumed that the asset is in open (empty) mode 453 at time 12:00:00 noon. From time 12:00:00 noon until time 12:00:24, no orders 535 are received.

At time 12:00:25, “Participant A” submits, and the system receives, a buy order for the asset 510. This order causes the system to transition to open (active) mode 454, as explained with regard to FIGS. 4A and 4B, and the system broadcasts a message to the market participants informing them of this mode change for the asset. At time 12:00:51, “Participant B” submits, and the system receives, a non-matching sell order for the asset 515. This sell order 515 compliments Participant A's buy order 510 and causes the system to change to potential match mode 455 for Participant A and Participant B with regard to the subject asset.

Upon entering potential match mode 455 at 12:00:51, the system starts a 60-second timer 540 for the asset to denote the initial negotiation session. The system also broadcasts a message to market participants (for example, all of the market participants) informing them that a negotiation has begun for the asset and encouraging them to participate by submitting an order before the timer expires and to become eligible for the next negotiation session. During the first timer period 525, at time 12:01:00, the system receives a sell order from “Participant C” 520 in response to being notified that the system has entered the potential match mode 425 for the asset, transitioning Participant C from potential match mode 455 to eligible mode 456 with respect to the asset. In one embodiment, the system notifies Participants A and B with information regarding the order of Participant C to encourage them to continue negotiating by submitting a price-improving order, while other participants that have not submitted orders for the asset are not notified regarding the order of Participant C.

At time 12:01:10, Participant A continues to negotiate by improving his buy order 527, for example, by raising the bid price. This causes Participant A to become eligible 456 for the next negotiation session.

Similarly, at time 12:01:25 Participant B improves his sell order 527, for example, by lowering the ask price, which causes Participant B to become eligible 456 for the next negotiation session.

At time 12:01:51, the asset timer expires 530, ending the first negotiation section, and the system resets the asset time 550 for a second 60-second negotiation session 570. Because Participants A, B, and C have improved their orders during the first negotiation session, they transition from the eligible mode 456 to the potential match mode 455 and remain in negotiation, while all other market participants return to the open (active) mode 454 with respect to the asset.

During the second negotiation session 570, at time 12:02:00, the system receives from Participant C an improved, but non-matching, sell order 545. Sell order 545 transitions Participant C to the eligible mode 456 for the asset. In one embodiment, Participants A and B are notified regarding the improved order of Participant C and may receive other incentives to continue negotiating.

At time 12:02:25, the system receives from Participant A an improved, but non-matching, buy order 555, which transitions Participant A to the eligible mode 456 for the asset. In one embodiment, the system notifies Participants B and C regarding the improved order of Participant A and may provide other incentives to encourage Participants B and C to continue negotiating. Nonetheless, Participant B fails to submit an order before the second negotiation session ends and exits the negotiation 565, transitioning to the open (active) mode 454 for the asset. In one embodiment, information regarding a potential match, such as countdown timer screen displays, mode icons, etc., are withdrawn from Participant B and replaced with just an open (active) mode indicator.

At time 12:02:51, when the asset timer expires ending the second negotiation section, the system resets the asset time 560 for a third 60-second negotiation session (not shown) and transitions Participants A and C to potential match mode 455. During the third session, Participants A and C are eligible to receive information regarding any orders for the asset and other incentives. The system no longer provides such information and incentives to Participant B because Participant B is no longer in the potential match mode 455 or eligible mode 456 for the asset.

In one embodiment consistent with the invention, other participants may enter a negotiation session by submitting a non-matching, price-improving order for the asset, and thus become eligible for the next negotiation session and incentives despite having missed previous negotiation sessions for the asset. Other participants may also enter matching orders and proceed to auction mode 457.

As explained previously, the negotiation sessions continue until either a match is made, resulting in an auction trade, or the system does not receive at least two complimentary price-improving orders for the asset during a negotiation session.

In one embodiment consistent with the invention, the system inserts a random time delay between when a participant enters their order and when the participant receives feedback regarding the current negotiation state, eligibility for the next negotiation session, system mode, etc., thus making it difficult for the participant to tell whether they initiated the negotiation or whether they joined or rejoined a negotiation. For example, when a participant rejoins a negotiation the system may insert a feedback delay of length anywhere from zero up to a full negotiation period length.

Market System

In one embodiment consistent with the invention, each participant interacts with a central server system using an interactive participant apparatus, such as a computer workstation that communicates with the central server via a data communication network.

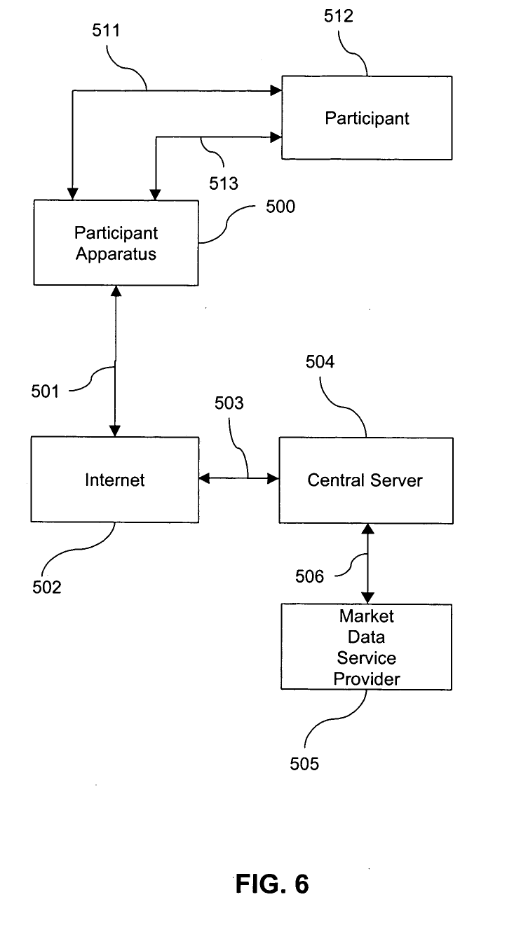

FIG. 6 is a diagram depicting a system consistent with the present invention. The system may be used to create and host an anonymous negotiation market with negotiation incentives. In the embodiment shown, a Participant 512, who may be a buyer or seller, negotiates asset prices with another participant by creating and/or modifying orders via an interactive computer application hosted on a Central Server 504. A Participant 512 communicates with the Central Server 504 via a Participant Apparatus 500. The Participant Apparatus 500 provides an interface whereby participants may create new orders and send them to the Central Server 504, cancel previously submitted orders that remain unmatched, receive notification from the Central Server 504 when any asset makes a transition from the quiet state to the negotiating state, receive notification from the Central Server 504 when a market-improving event occurs for any asset, receive information regarding the participant's current mode with respect to an asset, receive information regarding the time period for an ongoing asset negotiation session, and gain access to other incentives, notifications, and information regarding the status of assets in the market. The Participant Apparatus 500 may be any number of commercially available hardware and software workstation products or personal computers. The particular workstation hardware and software employed is not critical to the invention.

Participant 512 or other users of Participant Apparatus 500 may be natural persons acting for their own account or acting as agents for other legal entities. Further, it is well within the state of the art to assemble apparatus that could emulate the behavior of a natural person on the Participant Apparatus 500.

The Participant Apparatus 500 connects to the Central Server 504 via the Internet 502, or other conventional data communications network. As shown, the Participant Apparatus 500 connects to the Internet 502 via an Internet Access Service 501. An Internet Access Service 501 is typically provided by an Internet Service Provider (not shown). The data communication network connecting the Participant Apparatus 500 to the server 504 can be any of a number of commercially available networks. The particular data communication network employed is not critical to the invention.

Participant 512 may interact with the Participant Apparatus 500 remotely via a wireless connection 513, such as a cell phone, using a local connection 511, such as keyboard and mouse, or via other conventional means. Central Server 504 and Participant Apparatus 500 host software applications that support interactions initiated by the Participant 512.

In one embodiment consistent with the invention, the Central Server Computer 504 is configured with a software application(s) that performs the tasks associated with accepting orders from participants, comparing new orders to existing orders, executing a trade for orders that match, detecting market-improving events, assigning and setting countdown timers for assets in the negotiating state and for participants, communicating information to market participants and providing negotiation incentives.

One of ordinary skill in the art will recognize that standard design and programming techniques can be used to implement these functions, and the exact design and implementation employed is not critical to the invention.

In addition, the Central Server 504 hosts application software that supports an anonymous negotiation fungible asset market. For example, under software control, the Central Server 504 may make inquiries 506 to a Market Data Service Provider 505 to obtain information regarding the prices of assets in other markets such as the New York Stock Exchange. Participants may use this information to help formulate their own orders for the same types of assets. The Central Server 504 obtains assets prices from a Market Data Service Provider 505 by making electronic inquiries 506. The procedure for making electronic inquires to a particular market data service provider are typically unique for each market data service provider. The Market Data Service Provider 505 is an entity that provides information concerning the prices of assets in public markets. Reuters is one example of a well-known provider of these services. Beyond the need to provide accurate market prices, the selection of a particular market data service provider is not critical to the invention.

One of ordinary skill will realize that the components depicted in FIG. 6 can be easily added to, deleted, modified, or combined without departing from the principles of the present invention. For example, multiple instances of Market Data Service Providers 505, and Participant Apparatuses 500 could be employed, or the entire system shown in FIG. 6 could be duplicated in its entirety to either interact with similar systems or form separate discrete markets. The skilled artisan will further recognize that the functionality described for each component could be shifted to other components without departing from the principles of the invention. For example, a subset of the functions described for Central Server 504 may be carried out by Participant Apparatus 500.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for encouraging trades for fungible assets, comprising:
receiving a first order associated with a fungible asset from a first participant;
notifying a second participant that the order for the fungible asset has been received;
receiving a second order for the fungible asset from the second participant;
providing to the first participant an incentive to submit a new order associated with the fungible asset;
determining, as a function of at least one criteria, whether to withdraw the incentive; and
withdrawing the incentive based on whether the new order submitted by the first participant meets the at least one criteria.

2. The method of claim 1, wherein the incentive is information about another participant's order for the fungible asset, and wherein the information is not available to other participants that do not have a pending order for the fungible asset.

3. The method of claim 1, wherein the criteria is submission of the new order before the expiration of a period of time.

4. The method of claim 3, wherein the period of time begins nearly when the second order is received, and wherein the period of time is repeated if the first participant submits a new order for the fungible asset.

5. The method of claim 1, wherein the criteria is a better price in the new order than the price in the first order.

6. The method of claim 1, further comprising:
providing to the second participant a second incentive to submit a new order for the fungible asset; and
withdrawing the second incentive if the second participant does not submit a new order that meets at least one predetermined criteria.

7. The method of claim 6, wherein the incentive is information about another participant's order for the fungible asset, and wherein the information is not available to other participants that do not have a pending order for the fungible asset.

8. The method of claims 6, wherein the criteria is submission of the new order before the expiration of a period of time.

9. The method of claim 6, wherein the criteria is a better price in the new order than the price in the second order.

10. A system for encouraging trades for fungible assets, comprising:
means for receiving a first order associated with a fungible asset from a first participant;
means for notifying a second participant that the order for the fungible asset has been received;
means for receiving a second order for the fungible asset from the second participant;
means for providing to the first participant an incentive to submit a new order associated with the fungible asset;
means for determining, as a function of at least one criteria, whether to withdraw the incentive; and
means for withdrawing the incentive based on whether the new order submitted by the first participant meets the at least one criteria.

11. The system of claim 10, wherein the incentive is information about another participant's order for the fungible asset, and wherein the information is not available to other participants that do not have a pending order for the fungible asset.

12. The system of claim 10, wherein the criteria is submission of the new order before the expiration of a period of time.

13. The system of claim 10, wherein the period of time begins nearly when the second order is received, and wherein the period of time is reset each time the first participant submits a new order for the fungible asset.

14. The system of claim 10, wherein the criteria is a better price in the new order than the price in the first order.

15. The system of claim 10, further comprising:
means for providing to the second participant a second incentive to submit a new order for the fungible asset; and
means for withdrawing the second incentive if the second participant does not submit a new order that meets at least one predetermined criteria.

16. The system of claim 10, wherein the incentive is information about another participant's order for the fungible asset, and wherein the information is not available to other participants that do not have a pending order for the fungible asset.

17. The system of claim 10, wherein the criteria is submission of the new order before the expiration of a period of time.

18. The system of claim 10, wherein the criteria is a better price in the new order than the price in the second order.

19. A computer program product for encouraging trades for fungible assets with instructions for causing a processor to perform operations comprising:
receiving a first order associated with a fungible asset from a first participant;
notifying a second participant that the order for the fungible asset has been received;
receiving a second order for the fungible asset from the second participant;
providing to the first participant an incentive to submit a new order associated with the fungible asset;
determining, as a function of at least one criteria, whether to withdraw the incentive; and
withdrawing the incentive based on whether the new order submitted by the first participant meets the at least one criteria.

20. The computer program product of claim 19, wherein the incentive is information about another participant's order for the fungible asset, and wherein the information is not available to other participants that do not have a pending order for the fungible asset.

21. The computer program product of claim 19, wherein the criteria is submission of the new order before the expiration of a period of time.

22. The computer program product of claim 21, wherein the period of time begins nearly when the second order is received, and wherein the period of time is reset each time the first participant submits a new order for the fungible asset.

23. The computer program product of claim 19, wherein the criteria is a better price in the new order than the price in the first order.

24. The computer program product of claim 19, further comprising instructions for causing a processor to perform operations comprising:
providing to the second participant a second incentive to submit a new order for the fungible asset; and
withdrawing the second incentive if the second participant does not submit a new order that meets at least one predetermined criteria.

25. The computer program product of claim 24, wherein the incentive is information about another participant's order for the fungible asset, and wherein the information is not available to other participants that do not have a pending order for the fungible asset.

26. The computer program product of claim 24, wherein the criteria is submission of the new order before the expiration of a period of time.

27. The computer program product of claim 24, wherein the criteria is a better price in the new order than the price in the second order.

28. A method for encouraging trading of a fungible asset comprising:
a) receiving at least two complimentary orders for the fungible asset;
b) notifying a plurality of participants with information regarding the at least two complimentary orders;
c) starting a timer;
d) determining a subset of the plurality of participants, wherein the subset contains only participants that have submitted a market-improving order for the fungible asset before the timer expires; and
e) notifying the participants in the subset of the plurality of participants with information regarding the market-improving order.

29. The method of claim 28, further comprising:
f) repeating steps c) through d).

30. An apparatus for providing incentives for trading a fungible asset comprising:
a receiver for receiving a signal containing information describing at least two complimentary orders for the fungible asset;
a transmitter for broadcasting a signal notifying a plurality of participants with information regarding the at least two complimentary orders;
a timer for providing a signal at the expiration of a predetermined period of time;
a processor for determining a subset of the plurality of participants, wherein the subset contains only participants that have submitted a market-improving order for the fungible asset before the signal from the timer is provided; and
a transmitter for notifying the participants in the subset of the plurality of participants regarding an incentive for submitting a new order.

31. The apparatus of claim 30, wherein the incentive is information regarding the market-improving order.
